(19) United States
(12) Patent Application Publication
(10) Pub. No.: US 2006/0145507 A1
(43) Pub. Date: Jul. 6, 2006

(54) Pod device for mounting a gauge in a vehicle

(76) Inventor: Calvin Samuel Eng, West Orange, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/137,280

(22) Filed: May 25, 2005

Related U.S. Application Data
(60) Provisional application No. 60/640,963, filed on Dec. 30, 2004.

(51) Int. Cl. B62D 25/14

(52) U.S. Cl. 296/74; 296/37.8

(57) ABSTRACT

A pod device for mounting and displaying a gauge, preferably in a vehicle, includes a base member that integrates with the vehicle's original structure by directly replacing an original part of the vehicle, such as the vehicle's steering column. The pod device includes one or more cups secured to the base. The cups may be rotated and positioned freely to achieve the desired display of the gauge.

### CROSS REFERENCE TO RELATED APPLICATION

This application claims benefit of U.S. Provisional Application No. 60/640,963 filed Dec. 30, 2004. The entire disclosure of U.S. Provisional Application No. 60/640,963 is incorporated herein by reference.

### BACKGROUND OF THE INVENTION

1. Field of the Invention

The present invention relates to a mounting device attachable to a vehicle. Specifically, the present invention relates to an improved gauge-mounting device that integrates with the vehicle's existing structure by directly replacing an original part of the vehicle, such as the vehicle's steering column cover. Further, the device provides for dynamic adjustment of a position of a gauge mounted thereon.

2. Related Art

In the aftermarket of the vehicle industry, vehicles such as automobiles are modified to include additional instrumentation to measure parameters related to the vehicle's performance. The measurements or readings performed by these instruments are displayed using gauges, which may measure a variety of parameters related to the performance of the vehicle, such as, for example, the vehicle's fuel pressure.

Typically, the vehicle is fitted with a mounting apparatus to hold these gauges so that displayed information may be communicated to and accessed by an interested viewer, such as the vehicle's operator, a passenger, or a mechanic. A conventional mounting apparatus is a static “pod” that is fixedly secured to a base member. According to this conventional apparatus, a gauge is installed in the pod such that the gauge's position is fixed and may not be adjusted in any way to adapt to a viewer's visual perspective. However, different viewers may have different primary lines of sight. As such, gauges installed in statically positioned pods are difficult for viewers to view.

Generally, a conventional static pod mounting apparatus is installed in the vehicle by drilling into and fixing it to an original structure of the vehicle. One disadvantage to this installation approach is that drilling leaves holes in the vehicles which may need to be refilled or patched upon resale of the vehicle.

Another conventional static pod mounting apparatus is adapted to adhere to or overlay an original structure of the vehicle using a standard adhesive. For example, a static pod may be mounted on an A-pillar of the vehicle, known in the art as the structural upright that joins the windshield and the front side windows. However, many vehicles are equipped with air bags located in the A-pillar, commonly known as “side air bags”. If these air bags discharge, an overlying pod mounted thereon may become dislodged and projected towards individuals located in the vehicle, resulting in a danger to the vehicle's passengers.

An alternative position for a conventional static pod apparatus is overlying the steering column of the vehicle. However, a static pod overlying an existing steering column often severely impairs the driver's ability to view the standard instrumentation located in the vehicle's dashboard.

Accordingly, there exists a need in the art for a mounting solution that provides a safe and efficient display of a gauge in a vehicle.

### SUMMARY OF THE INVENTION

The present invention relates to a versatile “mounting solution” device that provides safe and easy access to information displayed by a gauge in a vehicle, including, but not limited to cars, motorcycles, trucks, bicycles, ATVs, mopeds, motor boats, wave runners, etc. Moreover, the present invention relates to a pod device with a base mountable in a vehicle. Attached to the base are one or more cups, wherein each cup is adapted to accept and securely house a gauge. The position of each cup may be dynamically rotated, tilted, adjusted, or moved at the discretion of the viewer. In addition, the position of each cup may be secured in a fixed position if desired by the viewer.

In an embodiment of the invention, the device may be a direct-fit replacement for an original equipment part of a vehicle, preferably the vehicle's steering column cover. This “direct fit replacement” of an original part of the vehicle allows for the device to be integrated into the vehicle and positioned in the normal line of sight of the vehicle operator. By replacing, instead of overlaying the steering column, the appropriate height of the pod is achieved such that there is minimal obstruction of the vehicle operator's view of the standard dashboard information display (i.e., the speedometer, the tachometer, the fuel gauge, etc.), typically located behind the steering wheel. Advantageously, the viewer may adjust the position of the cup to reduce or eliminate any obstruction of the dashboard display.

In an embodiment of the invention, the cups may be adapted to securely fit any standard-sized gauge. Advantageously, the position of the cups may be adjusted to allow for the gauge instrument information to be displayed to any viewer's line of sight or viewing angle. As such, the information displayed by the gauge may be viewed from any position in the vehicle. The cup may be freely rotated, moved and tilted to provide a safe and convenient display of the gauge to the driver or to another occupant of the vehicle. The device provides an easily adjustable gauge display that allows the viewer to adjust the angle of the gauge for optimal viewing.

### BRIEF DESCRIPTION OF THE DRAWINGS

The present invention will be more readily understood from the detailed description of the preferred embodiment(s) presented below considered in conjunction with the attached drawings, of which:

FIG. 1 is a perspective view of a pod device, according to an embodiment of the present invention;

FIG. 2 is rear view of a base of a pod device, according to an embodiment of the present invention;

FIG. 3 is a front view of a pod device, according to an embodiment of the present invention;

FIG. 4 is a rear view of a pod device, according to an embodiment of the present invention;

FIG. 5 is a side view of a cup with a ball joint partially encased by a base piece of a ball joint housing, according to an embodiment of the present invention;

FIG. 6 is a side view of a cup with a ball joint partially encased by a joining piece of a ball joint housing, according to an embodiment of the present invention;

FIG. 7 is a side view of a cup with a ball joint fully encased in a ball joint housing, according to an embodiment of the present invention;

FIG. 8 is a rear view of a cup with a ball joint partially encased by a base piece having a capsule, according to an embodiment of the present invention;

FIG. 8A shows an exemplary hex key for controlling a vice of a ball joint housing, according to an embodiment of the present invention;

FIG. 8B shows an exemplary hex key operating a vice of a ball joint housing, according to an embodiment of the present invention;

FIG. 8C shows a side view of a pod device, according to an embodiment of the present invention;

FIG. 9 is a rear view of a cup with a conversion sleeve fitted therein, and the conversion sleeve with the cup cut away, according to an embodiment of the present invention; and

FIG. 10 shows exemplary fitment sleeves and conversion sleeves, according to an embodiment of the present invention.

It is to be understood that the attached drawings are for the purpose of illustrating concepts of the present invention and may not be to scale.

### DETAILED DESCRIPTION OF THE INVENTION

The present invention relates to a pod device for mounting one or more gauges in a vehicle.

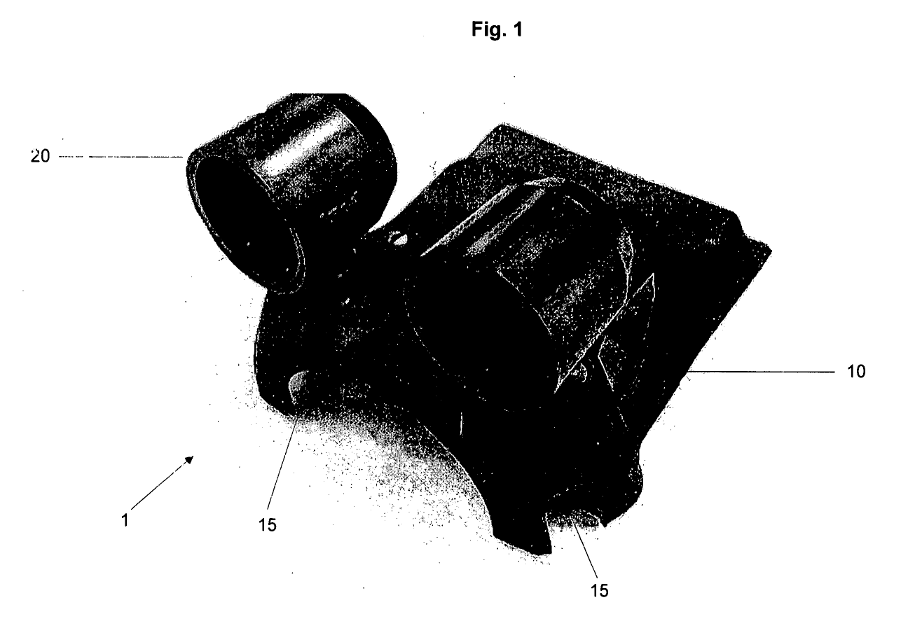

FIG. 1 depicts an exemplary pod device 1 according to an embodiment of the present invention. The pod device 1 includes a base 10 and one or more cups 20. The base 10 includes one or more tabs 15 designed to allow for a direct fit of the pod device 1 in place of an original equipment part of the vehicle. As such, the pod device 1 is referred to as a “direct fit replacement” of the vehicle's original equipment. The tabs 15 are sized and arranged to complement and align with the original equipment of the vehicle such that the pod device 1 may integrate with the original structure of the vehicle.

In a preferred embodiment, the pod device 1 is adapted to directly replace the vehicle's steering column cover. For example, to install the pod device 1 in a vehicle, the installer removes the original steering column cover and replaces it with the pod device 1. Other vehicle parts that may be replaced with a pod device similar to the pod device 1 include but are not limited to a speaker grill, a clock, or a dashboard.

Typically, different vehicle makes and models have different steering column structures, dimensions, and shapes. Accordingly, the shape and dimensions of the base 10 may be customized to directly fit any vehicle type. Optionally, the base 10 may be treated and texture coated to match the specifications of the vehicle's original equipment to integrate with the “look and feel” of the vehicle. The base 10 may be composed of any suitable material including but not limited to a material of the original part of the vehicle that the base 10 is replacing. In a preferred embodiment, the base 10 is composed of an acrylonitrile-butadiene-styrene (ABS) plastic or a polypropylene plastic.

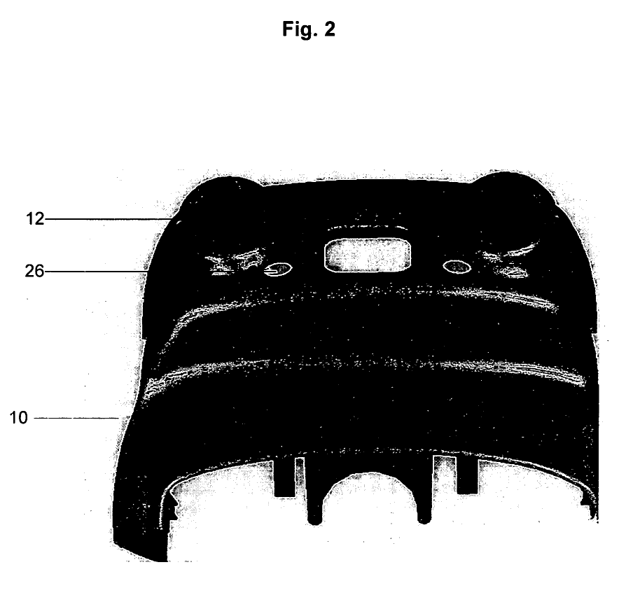

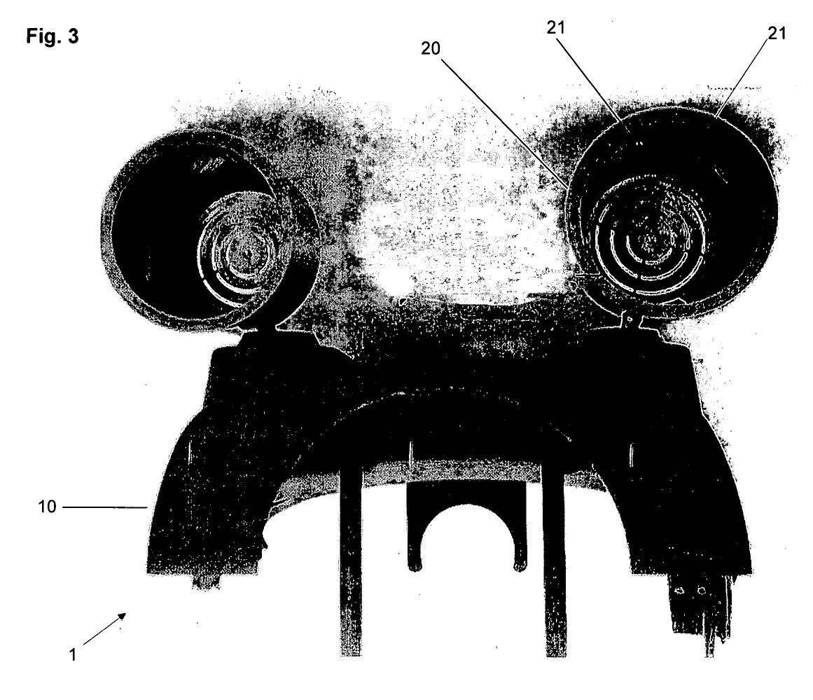

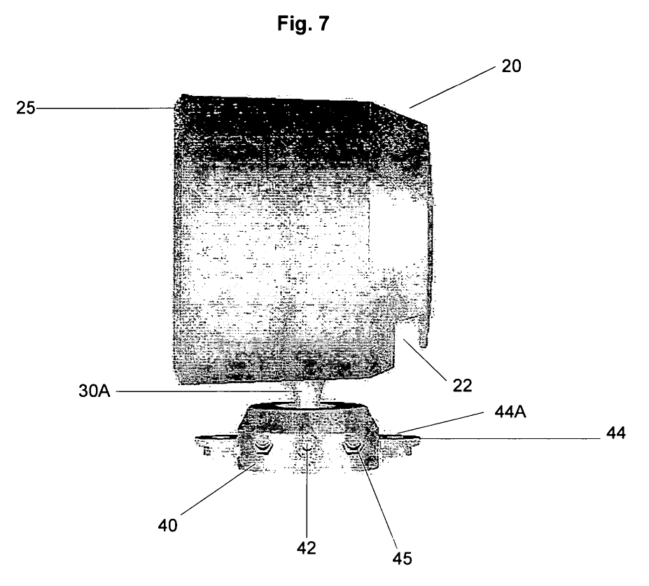

In an embodiment of the invention, the pod device 1 also includes one or more cups 20 adapted to attach to the base 10, as shown in FIG. 3. The cup 20 is a housing unit adapted to hold a display or other instrumentation, such as, preferably, a gauge. As shown in FIG. 2, the base 10 includes an integration area 12 where the cup 20 is attached. The cup 20 may be secured within the integration area 12 via any known securing mechanism, such as, for example, a conventional screw and nut arrangement. In a preferred embodiment, the cup 20 is first encased in a ball joint housing 40 (shown, for example, in FIG. 7), which in turn in secured to the integration area 12 of the base 10, as described in detail below. In a preferred embodiment, the cup 20 may be composed of an ABS plastic.

The cup 20 includes a front opening for accepting a gauge. Although the present invention is described in terms of the preferred embodiment of the invention wherein the pod device 1 includes two cups 20, one having ordinary skill in the art will appreciate that the pod device 1 may include any number of cups 20.

In an embodiment of the invention, the cup 20 may include a plurality of raised ribs or slots 21 spaced apart along the interior surface of the cup 20, as shown in FIG. 3. The raised slots 21 are integral to the interior surface of the cup 20 and provide friction against the surface of an object fitted within the cup 20, such as a gauge, a fitment sleeve 25 (described in detail below), or a conversion sleeve 50 (described in detail below).

The opening and internal housing of the cup 20 may be dimensioned to accept and securely hold a gauge of any size. In a preferred embodiment, the cup 20 is sized to securely house a standard 52 mm diameter gauge or a standard 60 mm diameter gauge.

Because the dimensions of standard-sized gauges (e.g., 52 mm and 60 mm gauges) may include varying tolerances from manufacturer to manufacturer, the cup 20 may be fitted with a fitment sleeve 25. The fitment sleeve 25 is adapted to securely fit within the cup 20. Once fitted in the cup 20, the fitment sleeve 25 provides sufficient friction to the gauge to enable the securing of gauges of varying dimensional tolerances. The fitment sleeve 25 may be composed of any compressible material, such as rubber, foam, etc. In a preferred embodiment, the fitment sleeve 25 is composed of a rubber.

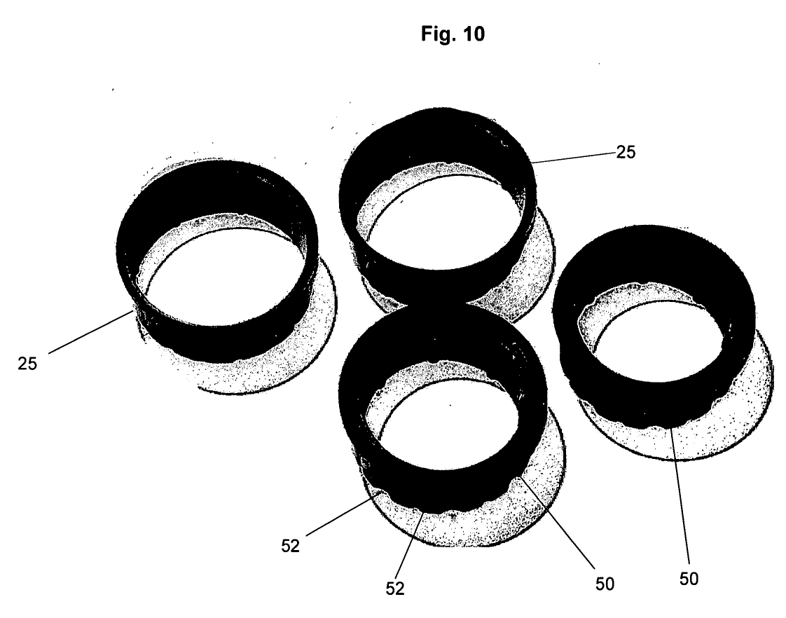

In a preferred embodiment, a portion of the fitment sleeve 25 to be inserted into the cup 20 includes a textured outer surface. The outer surface includes a plurality of raised and sunken ridges or slots (shown in FIG. 10) adapted to align with the raised slots 21 of the cup 20 such that, upon proper alignment, the fitment sleeve 25 securely fits within the cup 20.

In addition, the inner surface of the portion of the fitment sleeve 25 inserted into the cup 20 may include a plurality of raised ribs or slots. These raised slots function much like the raised slots 21 arranged on the interior surface of the cup 20, providing friction against the gauge and enabling a secure fit of the gauge within the fitment sleeve 25.

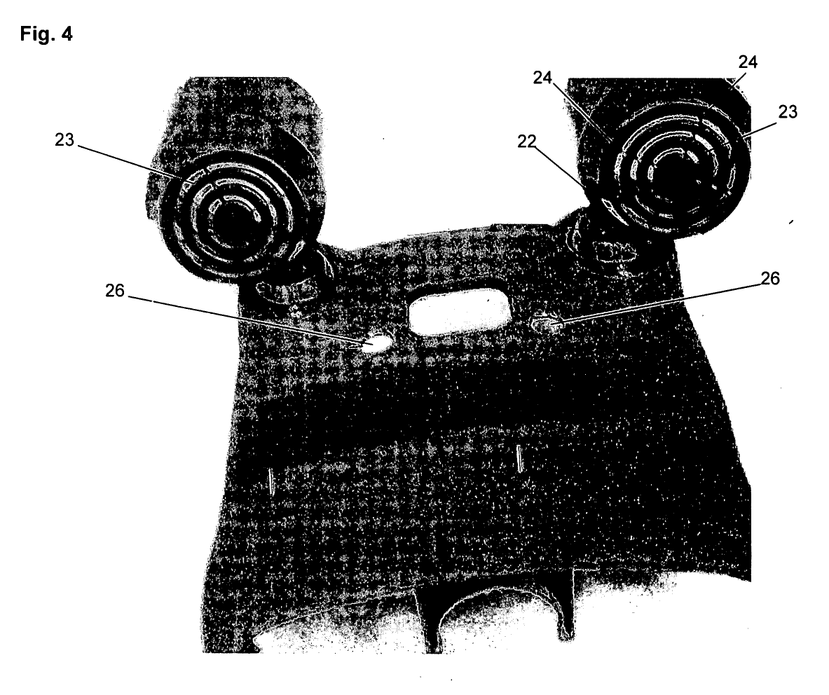

FIG. 4 depicts a rear perspective of the pod device 1 according to an embodiment of the present invention. The rear of the cup 20 includes a cable feed slot 22 to allow for the passage of any number or size of cables, vacuum lines, or other attachments to the gauge (collectively referred to as “cables”). In a preferred embodiment, the cable feed slot 22 is located at the bottom of the rear surface of the cup 20 (i.e., the end of the cup 20 attached to the base 10).

In one embodiment of the present invention, a portion of the rear wall of the cup 20 may be perforated such that the wall includes a number of individual removable sections 23. In its original form, the cup 20 includes a number of sections 23 connected together by one or more connection tabs 24. The sections 23 may be removed or “punched out” to increase the size of the rear opening to accommodate gauges having different sizes and shapes which may protrude beyond the rear surface of the cup 20. For example, mechanical gauges often include a nozzle at the rear of the gauge extending beyond the rear of the cup 20. As such, one or more of the sections 23 may be punched out to allow the nozzle to extend outs the rear of the cup 20. Optionally, depending on the position of the cables of a gauge to be fitted in the cup 20, the cables may extend through one or more sections 23 of the cup 20. In a preferred embodiment, a sections 23 may be removed by breaking the connection tabs 24 that connect the section 23 to be removed to an adjacent section 23. One of ordinary skill in the art will appreciate that any shape, size, and quantity of sections may be used.

The gauge cables fed through the cable feed slot 22 or through openings created by removing one or more sections 23 are run through one or more cable drop zones 26 located in the base 10. Advantageously, the cables that run through the cable drop zone 26 may be passed internally through the vehicle's dashboard and hidden from sight.

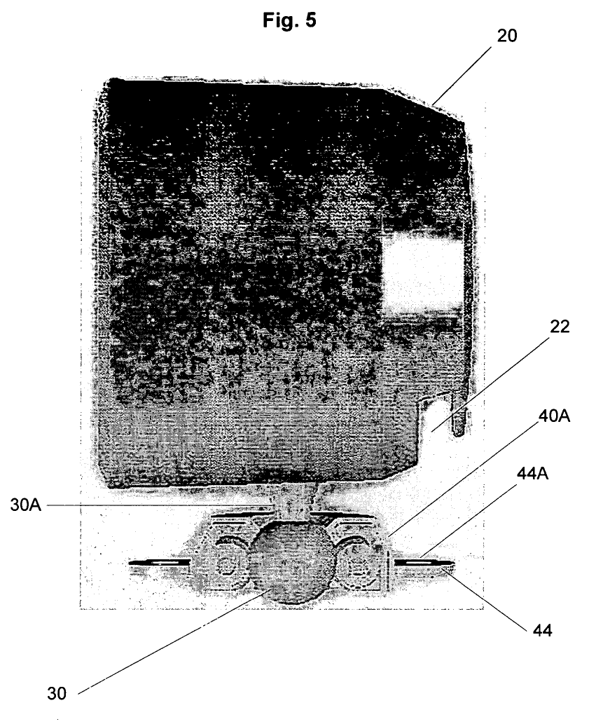

FIG. 5 shows a side view of the cup 20 according to an embodiment of the present invention. In a preferred embodiment, a ball joint 30 is located at an end of a stem 30A extending from the bottom side of the cup 20. One having ordinary skill in the art will appreciate that although the preferred embodiment of the present invention includes a ball joint 30 having a stem 30A, the ball joint 30 may be connected directly to the bottom side of the cup 20.

In a preferred embodiment, the ball joint 30 and the stem 30A are integral components of the cup 20 (i.e., the cup 20, the stem 30A, and the ball joint 30 are machined or formed as one piece). Alternative arrangements are contemplated, including but not limited to a separate composite piece, comprising a stem 30A and ball joint 30, which is attachable to the cup 20.

The ball joint 30 is adapted to fit within a ball joint housing 40 (see FIG. 7, for example). When in its non-fixed position within the ball joint housing 40, the ball joint 30 may be rotated to allow the cup 20 to rotate, swivel and/or tilt in any direction. The ball joint 30 provides a wide range of motion and allows an operator to adjust the rotation angle and tilt of each cup 20 independently of the other one or more cups 20 of the pod device 1. Advantageously, the cup 20 may be rotated freely 360 degrees, without limitation. Further, the cup 20 may be tilted in any manner desired, limited only by the physical structure of the pod device 1. Optionally, the ball joint housing 40 enables the ball joint 30 a limited amount of lateral movement when in the non-fixed position. Movement of the cup position may be hand adjusted. Further, fine adjustments to the position of the cup 20 may be made by the operator. Although the preferred embodiment of the cup 20 includes a stem 30A with a ball-shaped joint at the end adapted to be encased in a ball joint housing 40, one having ordinary skill in the art will appreciate that any type and shape joint arrangement may be used, with an important consideration being that the arrangement allows the cup 20 to move freely.

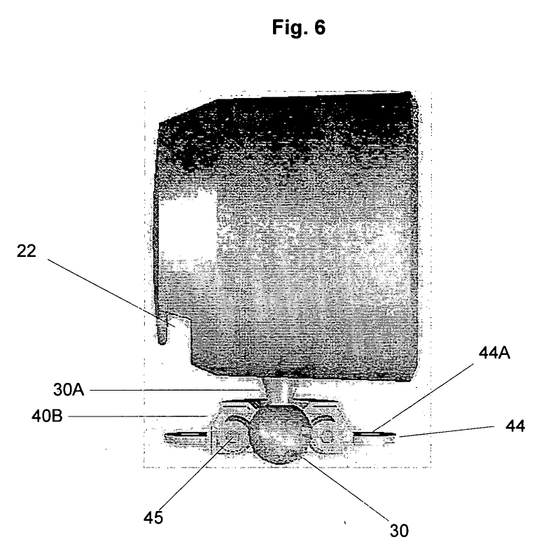

In an embodiment of the invention, the ball joint housing 40 encases the ball joint 30. The ball joint housing 40 includes a base piece 40A (see FIG. 5) and a complementary joining piece 40B (see FIG. 6) that join together to form the ball joint housing 40 (see FIG. 7). One having ordinary skill in the art will appreciate that the base piece 40A and the joining piece 40B may be adapted to join together according to any known method, including a “snap fit” arrangement. In addition, the underside of the ball joint housing 40 may include a ball-shaped opening. The ball shaped opening allows a portion of the ball joint 30 to extend at least partially into the opening, without interfering with the rotation or movement of the ball joint 30.

In a preferred embodiment, as shown in FIGS. 5 and 6, the base piece 40A and joining piece 40B each include openings 45, which when aligned, provide a clear passage for a securing mechanism, such as a screw, to secure the base piece 40A and joining piece 40B together to form the ball joint housing 40. In a preferred embodiment, a screw is passed through the aligned openings 45 and secured in place by a nut.

In an embodiment of the invention, the base piece 40A and joining piece 40B each include one or more securing tabs 44 for securing the ball joint housing 40 into the integration area 12 of the base 10. As shown in FIGS. 5-8, the securing tabs 44 include an opening 44A for allowing the passage of a screw or other known mechanical securing means. When the openings 44A of the securing tabs 44 of the pieces 40A, 40B are properly aligned, a slot is formed for accepting a securing mechanism, such as a screw.

In order to secure the cup 20 to the base 10, the ball joint housing 40 is secured around the ball joint 30. Then, the cup 20 and ball joint housing 40 combination are attached to the integration area 12 of the base 10 by fastening a screw through the openings 44A and corresponding openings in the integration area 12. In a preferred embodiment, the one or more screws attaching the cup 20 and ball joint housing 40 combination to the base 10 are further secured using one or more nuts. Furthermore, the integration area 12 may include a carved out or sunken region shaped and sized to accommodate the ball joint housing 40. One having ordinary skill in the art will appreciate that the ball joint housing 40 may be connected to the base 10 via any known securing mechanism, including but not limited to a magnetic, adhesive or mechanical means. The cup 20 and ball joint housing 40 secured in the integration area 12 of the base 10 is depicted in FIGS. 1, 3, 4 and 8C.

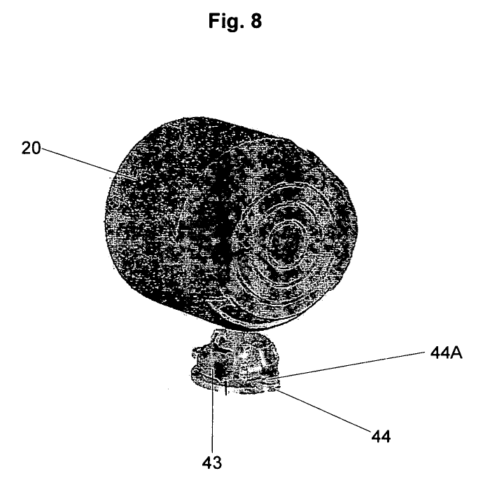

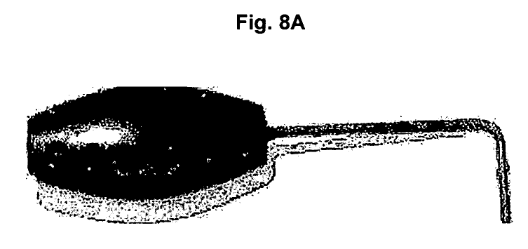

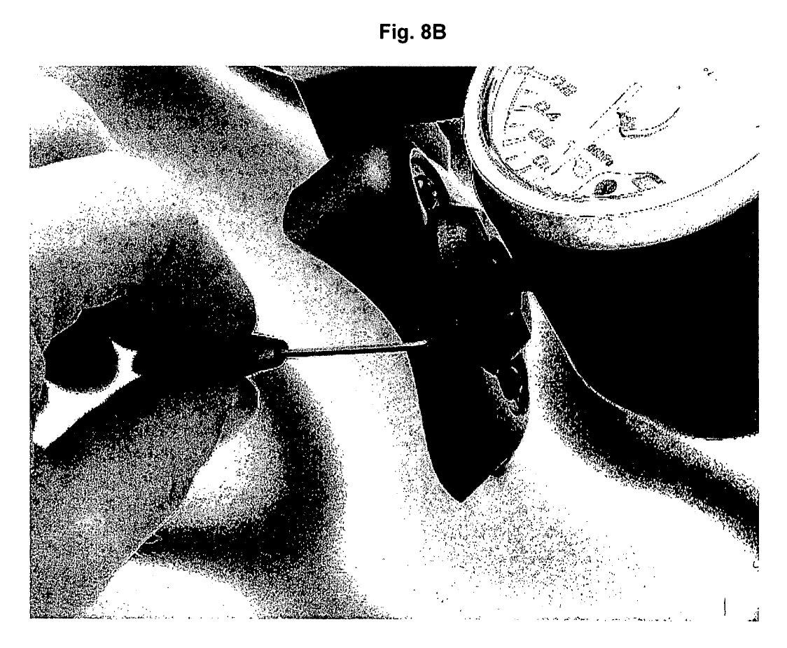

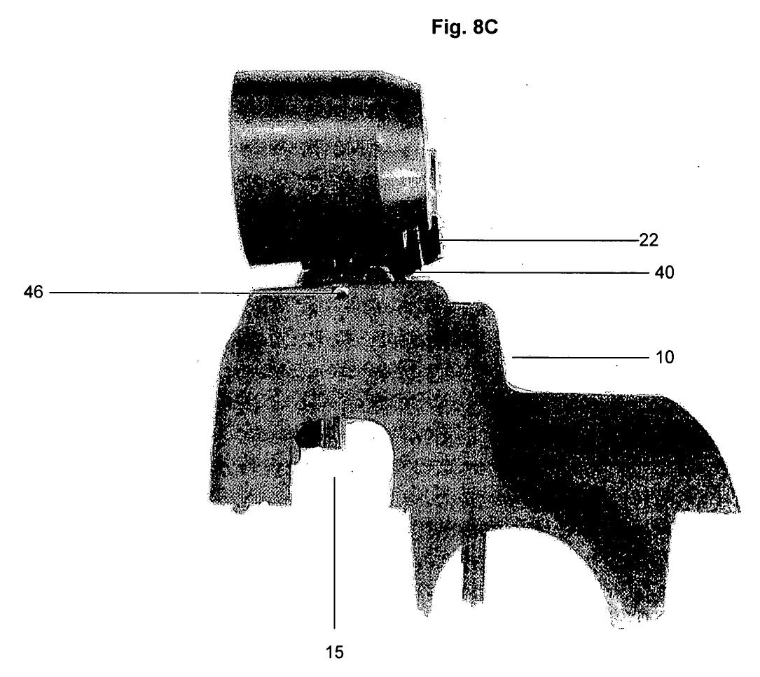

In an embodiment of the present invention, the ball joint housing 40 includes a vice 42 which allows for the tightening or loosening of the ball joint housing 40 around the ball joint 30. The vice 42 may be accessible via an outer side of the ball joint housing 40 and is operable by a known tool or key. In a preferred embodiment, the vice 42 is adjustable by a hex key, or other mechanical means. An exemplary hex key suitable for use with the pod device 1 is shown in FIG. 8A. According to this embodiment, the base 10 includes a vice key slot 46 that provides the operator with access to the vice 42, as shown in FIG. 8C.

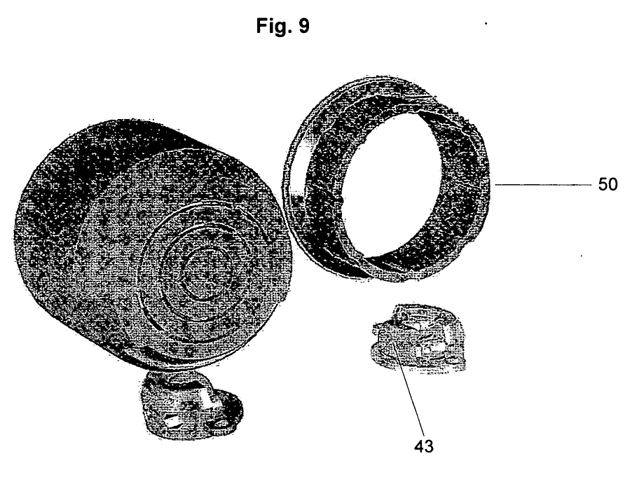

In addition, the ball joint housing 40 includes a capsule 43 (located in either the base piece 40A or the joining piece 40B), shown in FIG. 9. The capsule 43 is situated within the ball joint housing 40 such that the capsule 43 makes contact with the ball joint 30 when the ball joint housing 40 encases the ball joint 30. Further, the capsule 43 is positioned between the vice 42 and the ball joint 30 such that contact between the vice 42 and capsule 43 may be made. The capsule 43 may be comprised of any compliant material, such as, preferably, a rubber material. In a preferred embodiment, the capsule 43 includes a depression in its surface facing the ball joint 30 that is sized and shaped like the ball joint 30. One having ordinary skill in the art will appreciate that the capsule 43 may alternatively be included in the joining piece 40B, or both the base piece 40A and joining piece 40B may each include a capsule 43.

In operation, the operator places the vice key into the vice key slot 46 of the base 10 and engages the vice 42, as shown in FIG. 8B. To tighten the ball joint housing 40 around the ball joint 30, the key is turned causing the vice 42 to move toward the ball joint 40. The vice 42 moves into contact with the capsule 43 which in turn makes contact with the ball joint 30. Moving the capsule 43 into contact with the ball joint 30 changes the amount of frictional force applied to the ball joint 30. As such, the position of the cup 20 may be fixed by tightening the vice 42 such that sufficient frictional pressure is applied to the ball joint 40 by the capsule 43 to prevent movement of the ball joint 30. Furthermore, the vice 42 may be set to apply sufficient frictional force to fix the position of the cup 20 against movement due to natural forces such as gravity, or the shaking or bouncing of the vehicle. As such, the position of the cup 20 may be adjusted by hand.

Although the ball joint housing of the present invention is described as comprising two separate and adjoining pieces (40A and 40B), one having ordinary skill in the art will appreciate that the ball joint housing 40 may be one integral piece, with an important consideration being that it can accept and encase the ball joint 30. One having ordinary skill in the art will further appreciate that the ball joint housing 40 may be an integral part of the base 10 and the ball joint 30 may be integrally encased within the ball joint housing 40.

In an embodiment of the invention, the cup 20 may be fitted with a conversion sleeve 50, so named because it allows the diameter of the cup 20 to be converted to securely house any size gauge. The conversion sleeve 50 is loaded into the front opening of the cup 20 and fits securely within the cup 20. For example, a conversion sleeve 50 may be fitted within the cup 20 thereby reducing the diameter of the cup 20 from one that securely fits a standard 60 mm gauge to one that securely fits a standard 52 mm gauge.

Exemplary conversion sleeves 50 are shown in FIG. 1. The conversion sleeve 50 may be composed of any compressible material, such as rubber, foam, etc. In a preferred embodiment, the conversion sleeve 50 is composed of rubber.

Like the fitment sleeve 25, a portion of the conversion sleeve 50 which is inserted into the cup 20 may include a textured outer surface. The outer surface includes a plurality of raised and sunken ridges or slots 52 adapted to align with the arrangement of raised slots 21 of the cup 20 such that, upon proper alignment, the conversion sleeve 50 securely fits within the cup 20.

In addition, the interior surface of the conversion sleeve 50 may include a plurality of raised ribs or slots. The raised slots function much like the raised slots 21 arranged on the interior surface of the cup 20. The conversion sleeve's 50 raised slots provide friction against the gauge and enable a secure fit of the gauge within the conversion sleeve 50.

One having ordinary skill in the art will appreciate that the conversion sleeve 50 ring may be sized such that it adapts the cup 20 to accept and fit any sized or shaped gauge. In addition, one having ordinary skill in the art will appreciate that the conversion sleeve 50 may be used in conjunction with conventional static pods or other commercially-available cup-like housings. For example, one having ordinary skill in the art will appreciate that the conversion sleeve 50 may be fitted within a conventional 60 mm diameter gauge pod to convert the interior diameter of the pod to securely fit a standard 52 mm diameter gauge.

According to a preferred embodiment of the present invention, the pod device 1 is manufactured using a conventional injection molding process. Injection molding provides a high quality and consistent end product. Injection molding is preferred over other molding processes, such as vacuum molding and blow molding, both of which require very large tolerances and produce less consistent end products as compared to injection molding.

According to another embodiment of the invention, the pod device 1 may be UV treated, according to known techniques, to prevent discoloration, sagging, and/or deformation of the pod device 1 due to sunlight, heat, or other environmental conditions.

Although the present invention has been described in considerable detail with reference to certain preferred embodiments and version, other versions and embodiments are possible.

Therefore, the scope of the present invention is not limited to the description of the versions and embodiments expressly disclosed herein. The references and disclosure provided in the ‘Background of the Invention’ section are not admitted to be prior art with respect to the disclosure provided in the present application.

WHAT IS CLAIMED IS:

1. A device for mounting a gauge in a vehicle, the device comprising:
a base mountable in a vehicle, wherein the base is adapted to directly replace an original part or the vehicle; and
one or more cups attached to the base, wherein each cup is selectively positionable according to a viewer's preference and is adapted to securely house a gauge.

2. The device of claim 1, wherein the original part of the vehicle includes a steering column cover.

3. The device of claim 1, wherein each cup includes an adjustable ball joint.

4. The device of claim 3, wherein the ball joint is attached at an end of a stem extending from a bottom portion of the cup.

5. The device of claim 3, wherein the base includes a ball joint housing adapted to encase the ball joint such that the ball joint is free to rotate within the ball joint housing.

6. The device of claim 5, wherein the ball joint housing includes a vice for tightening and loosening the ball joint housing.

7. The device of claim 6, wherein the ball joint housing includes a capsule, and wherein movement of the vice causes the capsule to move into and out of contact with the ball joint and provide an adjustable degree of frictional force to the ball joint.

8. The device of claim 1, wherein an interior surface of each cup includes a plurality of raised portions adapted to securely engage a gauge inserted within the cup.

9. The device of claim 1, further comprising a fitment sleeve adapted to fit within at least one of the one or more cups, wherein the fitment sleeve allows the cup to secure gauges having varying tolerances.

10. The device of claim 9, wherein an exterior surface of the fitment sleeve includes a plurality of raised portions adapted to align with the slots of the cup, such that upon proper alignment, the fitment sleeve fits securely within the cup.

11. The device of claim 1, wherein each cup includes a cable feed slot for passage of one or more gauge cables.

12. The device of claim 1, wherein the base includes one or more cable drop zones for passage of one or more gauge cables.

13. The device of claim 1, wherein each cup includes a perforated rear wall delineating one or more removable sections.

14. The device of claim 1, wherein each cup is rotatable through 360 degrees.

15. The device of claim 1, wherein each cup is adapted to tilt.

16. The device of claim 1, further comprising a conversion sleeve adapted to fit within at least one of the one or more cups, wherein the conversion sleeve allows the cup to secure a gauge of a smaller size than an originally intended gauge size.

17. The device of claim 16, wherein an interior surface of the conversion sleeve includes a plurality of raised portions adapted to securely engage a gauge inserted within the conversion sleeve.

18. A sleeve for fitting within a vehicle-related gauge housing, the sleeve comprising:
a tubular ring formed of a compliant material and adapted to securely fit within a 60 mm diameter gauge housing, wherein the sleeve converts an interior diameter of the housing to securely fit a standard 52 mm diameter gauge.

19. A method for displaying information in a vehicle, the method comprising the steps of:
securing a gauge for displaying vehicle information within a pod device; and
directly replacing an original vehicle part with the pod device.

20. The method of claim 19, wherein the original vehicle part includes a steering column cover.

21. The method of claim 19, wherein the original vehicle part includes at least one of a vehicle grill, a clock, and a dashboard.
